(19) United States
(12) Patent Application Publication
(10) Pub. No.: US 2006/0243091 A1
(43) Pub. Date: Nov. 2, 2006

(54) Gas insulated switchgear

(75) Inventors: Daisuke Yoshida, Tokyo (JP); Haruhiko Kohyama, Tokyo (JP); Yuji Yoshitomo, Tokyo (JP)

Correspondence Address: BUCHANAN, INGERSOLL & ROONEY PC, POST OFFICE BOX 1404, ALEXANDRIA, VA, 22313-1404, US

(73) Assignee: MITSUBISHI DENKI KABUSHIKI KAISHA, Tokyo (JP)

(21) Appl. No.: 11/414,343

(22) Filed: May 1, 2006

(30) Foreign Application Priority Data
May 2, 2005 (JP) 2005-133791

(51) Int. Cl. F16H 53/00

(52) U.S. Cl. 74/567

(57) ABSTRACT

The gas insulated switchgear includes a rotary shaft which penetrates a pressure vessel is connected with a moving parts which is housed in the pressure vessel by way of a lever, and is connected to the moving parts, and brackets which support the rotary shaft and are mounted on a mounting portion which is formed on the pressure vessel. The brackets are fixed to the mounting portion formed on the pressure vessel using a plurality of fixing bolts which are arranged in a spaced-apart manner on an eccentric circle having the center at a point x2 offset from the center of rotation x1 of a rotary shaft and hence, the brackets can be fixed to the mounting portion formed on the pressure vessel at a predetermined angular position which uses the point x2 offset from the center of rotation x1 of the rotary shaft as the center of rotation.

### BACKGROUND OF THE INVENTION

1. Field of the Invention

The present invention relates to a gas insulated switchgear, and more particularly to an open/close operating device of a gas insulated switchgear which performs an open/close operation of a moving parts which is housed in a pressure vessel which is filled with an insulation gas.

2. Description of the Related Art

In an open/close operating device of a gas insulated switchgear in which a rotary shaft which is connected to a moving parts and is housed in a pressure vessel filled with an insulation gas penetrates the pressure vessel, it is necessary to adjust a connecting member and the moving parts which are mounted on the rotary shaft to an intended position that can assure the performance of the switchgear by correcting tolerances of parts and assembling.

To drive respective phases using a single operating device, by adjusting a length of a rod which connects the operating device and a lever of a rotary shaft at the time of converting an output of the operating device into a rotational force, it is possible to adjust an angle of the rotary shaft. However, parts which constitute the operating device become complicated.

On the other hand, when three phases are driven by one operating device, the mounting of a mechanism which adjusts axial angles of respective phases on a rotary portion is difficult from a viewpoint of working tolerance or easiness of assembly and it is necessary to connect between respective phases using a linearly movable rod whose length is adjustable and hence, there arises a drawback that constitutional parts become complicated and a movable mass is increased.

In the related art, with respect to such positional adjustment of the connecting member of the rotary shaft and the movable part, there has been proposed a technique in which there is provided a collar which includes a first spline hole portion which is eccentrically formed in an inner surface which allows the fitting of a first spline shaft portion of a rotary shaft and a second spline shaft portion which is formed in an outer surface which is fitted in a second spline hole portion of a lever which constitutes a connecting member, and the positional relationship is adjusted based on the fitting state of the first spline hole portion of the collar with respect to the first spline shaft portion of the rotary shaft (see, for example, JP-UM-A-4-66026).

Further, there has been also proposed a technique which adjusts the positional relationship by changing the circumferential position of an eccentric shaft by the insertion and the removal of a key (for example, JP-UM-A-55-85741).

However, in these related arts, the positional relationship is adjusted by directly changing over the connecting portions of the members by which a manipulating force is transmitted and hence, when a moving parts is manipulated by allowing this type of manipulating mechanism to pass through a vessel which is filled with an insulating gas, it is necessary to release a sealed state of the vessel at the time of performing the changeover adjustment and, at the same time, there arises a possibility that a trouble occurs in the connecting operation attributed to the positional adjustment.

### SUMMARY OF THE INVENTION

The invention has been provided to enable the acquisition of a gas insulated switchgear which can adjust the connection positional relationship between a moving parts and a rotary shaft member which are housed in a vessel while properly supporting the rotary shaft member which penetrates the vessel filled with an insulation gas using bearing members and holding a sealed state without disassembling a gas sealing portion and the moving parts.

A gas insulated switchgear according to the invention includes: a rotary shaft member which penetrates a pressure vessel which is filled with an insulation gas, is connected with a moving parts which is housed in the pressure vessel by way of a connecting member, and is interlockingly movable with the moving parts; and bearing members which support the rotary shaft member and are mounted on a mounting portion formed on the pressure vessel, wherein the bearing members are fixed to the mounting portion at a predetermined angular position which uses a point offset from the center of rotation of the rotary shaft member as the center of rotation.

According to the invention, it is possible to acquire the gas insulated switchgear which can adjust the connection positional relationship between a moving parts and a rotary shaft member which are housed in a vessel while properly supporting the rotary shaft member which penetrates the vessel filled with an insulation gas using bearing members and holding a sealed state without disassembling a gas sealing portion and the moving parts.

### BRIEF DESCRIPTION OF THE DRAWING

FIG. 1 is a longitudinal cross-sectional view showing the constitution of a gas insulated switchgear of an embodiment according to the invention;

FIG. 2 is a side view showing the constitution of the gas insulated switchgear according to the embodiment of the invention; and

FIG. 3A to FIG. 3C are side views for explaining a size adjusting operation of the gas insulated switchgear of the embodiment according to the invention.

### DESCRIPTION OF THE PREFERRED EMBODIMENTS

### Embodiment 1

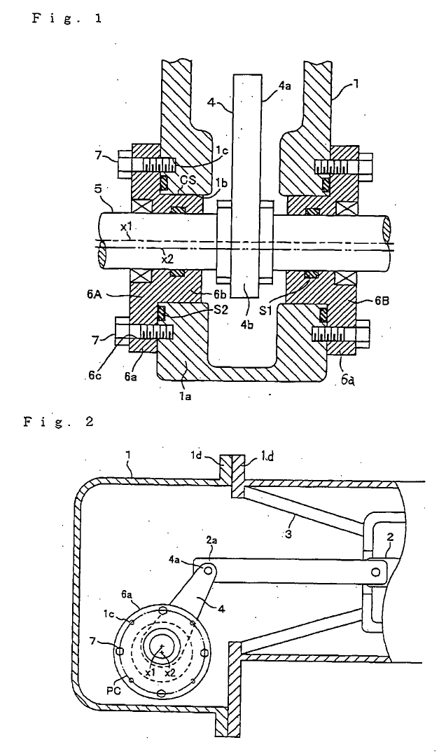

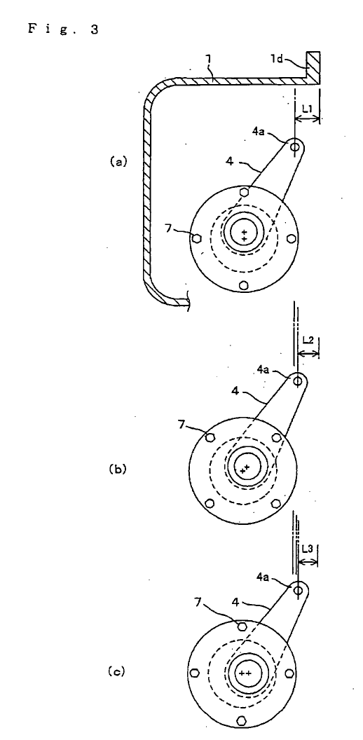

A gas insulated switchgear of the embodiment 1 according to the invention is explained in conjunction with FIG. 1 to FIG. 3C. FIG. 1 is a longitudinal cross-sectional view showing the constitution of the gas insulated switchgear of the embodiment according to the invention, FIG. 2 is a side view showing the constitution of the gas insulated switchgear according to the embodiment of the invention, FIG. 3A to FIG. 3C are side views for explaining a size adjusting operation of the gas insulated switchgear of the embodiment according to the invention.

In FIG. 1 and FIG. 2 which show the constitution of the gas insulated switchgear of the embodiment of the invention, an insulation gas such as SF₆ is filled in a pressure vessel 1. A moving parts 2 which includes a movable contact portion which faces a fixed contact portion in an opposed manner is housed in the inside of the pressure vessel 1 and is supported on an insulation member 3 in an insulated manner.

The moving parts 2 is connected to a lever 4 at a distal connection portion 4a thereof which moves in the peripheral direction due to the rotation of a lever 4, while a proximal portion 4b of the lever 4 which constitutes the center of rotation of the lever 4 is connected to a rotary shaft 5.

Both ends of the rotary shaft 5 penetrate the pressure vessel 1 which is filled with the insulation gas and are supported on a pair of brackets 6A, 6B. The brackets 6A, 6B have disc-shaped flange portions 6a thereof mounted on a mounting portion 1a of the pressure vessel 1 using fixing bolts 7. A sealing member S1 is provided between a peripheral surface of the rotary shaft 5 and the brackets 6A, 6B. Fitting portions 6b of the brackets 6A, 6B are fitted with the surface of the openings 1b which are formed in the mounting portion 1a of the pressure vessel 1.

In the mounting portion 1a of the pressure vessel 1, with respect to respective brackets 6A, 6B, eight threaded holes 1c which are arranged on an eccentric circle PC about an eccentric center axis x2 which is offset from a rotation center axis x1 of the rotary shaft 5 by a predetermined distance are formed at an equally spaced-apart manner from each other. In the flange portions 6a of the respective brackets 6A, 6B, four bolt insertion holes 6c are formed on the eccentric circle PC about the eccentric center axis x2 corresponding to eight threaded holes 1c formed in the mounting portion 1a of the pressure vessel 1. Fixing bolts 7 are inserted into these bolt insertion holes 6c and the fixing bolts 7 are threaded into four threaded holes 1c out of eight threaded holes 1c formed in the mounting portion 1a of the pressure vessel 1 whereby the brackets 6A, 6B are fastened to the mounting portion 1a of the pressure vessel 1. Sealing members S2 are provided between the flange portions 6a of the brackets 6A, 6B and the mounting portion 1a of the pressure vessel 1 and a sealing state is ensured by fastening the flange portions 6a of the brackets 6A, 6B to the mounting portion 1a of the pressure vessel 1.

Here, the fitting portions 6b of the brackets 6A, 6B which are fitted in the fitting holes 1b formed in the mounting portion 1a of the pressure vessel 1 have a disc-like shape having a circumferential surface about the eccentric center axis x2 which extends in the direction perpendicular to the extending direction of the flange portions 6a of the brackets 6A, 6B. Further, the fitting portions 6b of the brackets 6A, 6B are fitted in the circular fitting holes 1b formed in the mounting portion 1a of the pressure vessel 1 thus constituting a fitting structure portion CS. The fitting structure portion CS performs a function of reducing a size and the number of fixing bolts 7 by reducing a load applied in the direction perpendicular to axes of the fixing bolts 7.

The position adjusting operation, i.e. position adjustment process, of the gas insulated switchgear is explained in conjunction with FIG. 3

A state shown in FIG. 3(a) shows a positional relationship which is substantially equal to a positional relationship of the gas insulated switchgear shown in FIG. 2, wherein the distal end portion 4a of the lever 4 which is connected to the moving parts 2 at the connecting portion 2a with the lever 4 assumes the leftmost position in the drawing (see FIG. 2) and is arranged at a position away from an abutting surface of a flange portions 1d,1d of the pressure vessel 1 toward the left side by a distance L1.

In moving and adjusting the position of the distal end portion 4a of the lever 4 which is connected to the connecting portion 2a of the moving parts 2 with the lever 4 to the right side in the drawing, four fixing bolts 7 which fasten the flange portions 6a of the brackets 6A, 6B to the mounting portion 1a of the pressure vessel 1 are removed, and the flange portions 6a of the brackets 6A, 6B are rotated in the clockwise direction in the drawing by 45° so as to align the bolt insertion hole 6c which are formed in the flange portions 6a of the brackets 6A, 6B with the threaded holes 1c neighboring to the threaded holes 1c which are formed in the mounting portion 1a of the pressure vessel 1 and with which the fixing bolts 7 are already threadedly engaged, and four fixing bolts 7 are threadedly engaged with the neighboring threaded holes 1c. Due to such a constitution, with the use of these four fixing bolts 7 which penetrate the bolt insertion holes 6c which are formed in the flange portions 6a of the brackets 6A, 6B, the flange portions 6a of the brackets 6A, 6B are again fastened to the mounting portion 1a of the pressure vessel 1 and hence, a state shown in FIG. 3(b) is established.

In the state shown in FIG. 3(b), the distal end portion 4a of the lever 4 which is connected to the connecting portion 2a of the moving parts 2 with the lever 4 (see FIG. 2) is moved to a right side in the drawing and assumes a position which is on the side righter than L1 in FIG. 3A and away from the abutting surface of a flange portion 1d of the pressure vessel 1 toward the left side by a distance L2. Accordingly, it is possible to perform the positional adjustment.

The positional adjustment hereinbefore permits to exchange the moving parts 2 and/or the connecting portion 2a to another one without disassembling the pressure vessel 1 and the brackets 6A, 6B. The support state of the rotary shaft 5 and the brackets 6A, 6B is also maintained in the same manner and the operational state is ensured without obstructing the rotational operation of the rotary shaft 5.

In moving and adjusting the distal end portion 4a of the lever 4 which is connected to the connecting portion 2a of the moving parts 4 with the lever 2 to the further left side in the drawing from the state shown in FIG. 3B, four fixing bolts 7 which fasten the flange portions 6a of the brackets 6A, 6B to the mounting portion 1a of the pressure vessel 1 are removed, and the flange portions 6a of the brackets 6A, 6B are further rotated in the clockwise direction in the drawing by 45° so as to align the bolt insertion holes 6c which are formed in the flange portions 6a of the brackets 6A, 6B with the threaded holes 1c neighboring to the threaded holes 1c which are formed in the mounting portion 1a of the pressure vessel 1 and with which the fixing bolts 7 are already threadedly engaged, and four fixing bolts 7 are threadedly engaged with the neighboring threaded holes 1c. Due to such a constitution, with the use of these four fixing bolts 7 which penetrate the bolt insertion holes 6c which are formed in the flange portions 6a of the brackets 6A, 6B, the flange portions 6a of the brackets 6A, 6B are again fastened to the mounting portion 1a of the pressure vessel 1 and hence, a state shown in FIG. 3C is established.

In the state shown in FIG. 3(c), the distal end portion 4a of the lever 4 which is connected to the connecting portion 2a of the moving parts 2 with the lever 4 (see FIG. 2) is moved to a right side in the drawing and assumes a position which is on the side righter than L2 in FIG. 3B and away from the abutting surface of a flange portion 1d of the pressure vessel 1 toward the left side by a distance L3. Accordingly, it is possible to perform the positional adjustment.

Here, in shifting from the state shown in FIG. 3B to the state shown in FIG. 3C, the sealing action between the rotary shaft 5 and the fitting portions 6b of the brackets 6A, 6B and the sealing action between the mounting portion 1a of the pressure vessel 1 and the flange portions 6a of the brackets 10 6A, 6B are continuously performed by the shaft sealing members S1 and the sealing member S2 and hence, there is no possibility that the sealing state is broken. The support state of the rotary shaft 5 and the brackets 6A, 6B is also maintained in the same manner and the operational state is ensured without obstructing the rotational operation of the rotary shaft 5.

In this manner, the flange portions 6a of the brackets 6A, 6B can be fixed using the plurality of fixing bolts 7 which are arranged in a spaced-apart manner on the eccentric circle PC which has the center of rotation x2 thereof offset from the center of rotation x1 of the rotary shaft 5 and, the positional adjustment of the distal end portion 4a of the lever 4 can be performed by removing the fixing bolts 7 and by mounting the fixing bolt 7 again after rotating the flange portions 6a of the brackets 6A, 6B.

Here, in the embodiment shown in FIG. 1 to FIG. 3, the explanation has been made with respect to a case in which eight threaded holes 1c are formed in the mounting portion 1a of the pressure vessel 1, eight bolt insertion holes 6c are formed in the flange portions 6a of the brackets 6A, 6B, and the flange portions 6a of the brackets 6A, 6B are fastened to the mounting portion 1a of the pressure vessel 1 using four fixing bolts 7 which penetrate the bolt insertion holes 6c and are threadedly engaged with the threaded holes 1c. However, in an actual operation, sixteen threaded holes 1c are formed in the mounting portion 1a of the pressure vessel 1, four bolt insertion holes 6c are formed in each of the flange portions 6a, 6a of the brackets 6A, 6B, and the flange portions 6a of the brackets 6A, 6B are fastened to the mounting portion 1a of the pressure vessel 1 using, for example, eight fixing bolts 7 which penetrate the bolt insertion holes 6c corresponding to some of these threaded holes 1c at an equal interval.

Due to such actual constitution, the flange portions 6a of the brackets 6A, 6B can be rotatably adjusted for every 22.5° and hence, the fine adjustment of the positional relationship of the distal end portion 4a of the lever 4 can be achieved.

According to the embodiment of the invention, in the switchgear having the structure which transmits a driving force generated by the manipulating device in air to the moving parts in gas by way of the rotary shaft seal, the bolts 7 for fixing the brackets 6A, 6B which hold the rotary shaft 5 to the pressure vessel are arranged on the circumference about the rotary shaft 5 while being offset from the rotary shaft 5.

By rotating the above-mentioned brackets 6A, 6B about the center of a pitch circle PC of fixing bolts as an axis, it is possible to move the center x1 and the position of the lever 4 which is rotated about the rotary shaft 5 due to the offset of the center axis x2 and hence, it is possible to correct the tolerances of parts and assembly without disassembling the gas sealed portion and the moving parts thus adjusting the position of the moving parts in gas.

According to the embodiment of the invention, the gas insulated switchgear includes the rotary shaft member formed of the rotary shaft 5 which penetrates the pressure vessel 1 which is filled with an insulation gas, is connected with the moving parts 2 including the movable contact element which is housed in the pressure vessel 1 by way of the connecting member formed of the lever 4, and is interlockingly movable with the moving parts 2; and bearing members formed of the brackets 6A, 6B which support the rotary shaft member formed of the rotary shaft 5 and are mounted on the mounting portion 1a formed on the pressure vessel 1, wherein the bearing members formed of the brackets 6A, 6B are fixed to the mounting portion 1a formed on the pressure vessel 1 using the plurality of fixing bolts 7 which are arranged in a spaced-apart manner on the eccentric circle PC having the center at the point x2 offset from the rotary center x1 of the rotary shaft member formed of the rotary shaft 5 and hence, the bearing members formed of the brackets 6A, 6B can be fixed to the mounting portion 1a formed on the pressure vessel 1 at a predetermined angular position which uses the point x2 offset from the center of rotation x1 of the rotary shaft member formed of the rotary shaft 5 as the center of rotation. Accordingly, by mounting or dismounting the fixing bolts, it is possible to acquire the gas insulated switchgear which can adjust the connection positional relationship between the moving parts and the rotary shaft member which are housed in the pressure vessel while holding a state in which the bearing member properly supports the rotary shaft member which penetrates the pressure vessel without disassembling the gas sealing portion and the moving parts.

Further, according to this embodiment of the invention, in the above-mentioned constitution, the fitting structure CS which has the circumference thereof having the same center as the eccentric circle PC is arranged between the bearing members which are formed of the brackets 6A, 6B and the bearing members support portions which are formed of the fitting holes 1b in which the fitting portions 6b of the bearing members formed of the brackets 6A, 6B are fitted, wherein the fitting holes 1b are formed in the mounting portion 1a which, in turn, is formed on the pressure vessel 1 to support the bearing members which are formed of the brackets 6A, 6B. Accordingly, by mounting or dismounting the fixing bolts, it is possible to acquire the gas insulated switchgear which can adjust the connecting positional relationship between the moving parts and the rotary shaft member which are housed in the pressure vessel while holding a state in which the bearing member properly supports the rotary shaft member which penetrates the pressure vessel without disassembling the gas sealing portion and the moving parts. Further, by reducing the stresses which are applied to the fixing bolts in the fastening direction and in the direction perpendicular to the fastening direction, it is possible to reduce the size and the number of fixing bolts.

What is claimed is:

1. A gas insulated switchgear comprising:
a rotary shaft member which penetrates a vessel which is filled with an insulation gas, is connected with a moving parts which is housed in the vessel by way of a connecting member, and is interlockingly movable with the moving parts; and
bearing members which support the rotary shaft member and are mounted on a mounting portion formed on the vessel, wherein
the bearing members are fixed to the mounting portion at a predetermined angular position which uses a point offset from the center of rotation of the rotary shaft member as the center of rotation.

2. A gas insulated switchgear comprising:
A rotary shaft member which penetrates a vessel which is filled with an insulation gas, is connected with a moving parts which is housed in the vessel by way of a connecting member, and is interlockingly movable with the moving parts; and
bearing members which support the rotary shaft member and are mounted on a mounting portion formed on the vessel, wherein
the bearing members are fixed to the mounting portion using a plurality of bolts which are arranged in a spaced apart manner on an eccentric circle which is offset from the center of rotation of the rotary shaft member.

3. A gas insulated switchgear according to claim 2, wherein the fitting structure having a circumference about the same center as the eccentric circle is arranged between the bearing members and bearing members support portions of the vessel which support the bearing members.
